(19) United States
(12) Patent Application Publication
(10) Pub. No.: US 2022/0242003 A1
(43) Pub. Date: Aug. 4, 2022

(54) ALIGNMENT JIG FOR SAW

(71) Applicant: Greg Gaudenzi, Newtown, CT (US)

(72) Inventor: Greg Gaudenzi, Newtown, CT (US)

(21) Appl. No.: 17/163,517

(22) Filed: Jan. 31, 2021

(51) Int. Cl. B27B 9/04

(52) U.S. Cl. CPC B27B 9/04

(57) ABSTRACT

A jig apparatus to allow cutting straight lines in sheets of material using a portable tool with a cutting blade is disclosed. This apparatus includes a system or jig to hold the hold the portable tool in place, and keep it aligned at a specific angle, typically perpendicular but with angles other than perpendicular in some embodiments, to the edge of the sheet of material as the tool moves through the material, cutting it. In particular the portable cutting tool may be a circular saw.

### CROSS REFERENCE TO RELATED APPLICATIONS

None

### BACKGROUND OF THE INVENTION

### REFERENCES

N/A

### SUMMARY DISCLOSURE OF INVENTION

The invention described herein relates generally to an apparatus or jig which attaches to a cutting device such as a saw in order to allow it to cut a straight line in a sheet of material more effectively. In particular, in a preferred embodiment it attaches to a hand held circular saw to allow it to cut a straight line in a predetermined direction in wood.

One embodiment of this invention has one or more ends to press against the side of a board, aligning the saw when the jig is attached, and a spring loaded arm to allow the saw to move forward, cutting the board and keeping pressure from the jig on the board to keep the saw aligned. One embodiment of this invention has adjustable sections, to select predetermined cut directions other than cuts perpendicular to the edge of the sheet of material.

### BRIEF DESCRIPTION OF DRAWINGS

FIG. 1a shows a perspective view of a diagram of the jig, illustrating the upper arm with spring loaded section and the lower projecting arms with feet. FIG. 1B shows a magnified view and cross section of an attachment point for the jig to be attached to a cutting tool (not shown).

FIG. 1C shows the same section as FIG. 1B with a screw or bolt to attach the jig to a cutting tool (not shown).

FIG. 2 shows a rear end view of the jig, attached to a circular saw.

FIG. 3 shows a side view of the jig, attached to a circular saw, with a board.

FIG. 4 shows a bottom view of the jig pressed against a sheet of material with adjustment of relative lengths of lower projecting legs and rotation of the feet on the lower projecting legs on pivots.

### MODE(S) FOR CARRYING OUT THE INVENTION—DETAILED DESCRIPTION

The present invention and its various embodiments are described below, with reference to figures as necessary. Reference numbers are used to match particular elements described in the text with those shown in figures. Although the embodiments disclosed will be described with reference to the embodiments shown in the drawings, it should be understood that the embodiments disclosed can be embodied in many alternate forms, and the claims cover such alternate forms as well as combinations of the embodiments shown. In addition, any suitable size, shape or type of elements or materials could be used.

In particular, while this invention may be discussed in relation to its use with a circular saw, it could clearly be used with a variety of cutting tools which may have cutting blades, such as, but not limited to, a dremel blade cutting tool, a jig saw or Sawzall. All discussions of the circular saw jig should be considered to apply to this wider range of cutting tools as well, with appropriate adjustment of dimensions as needed.

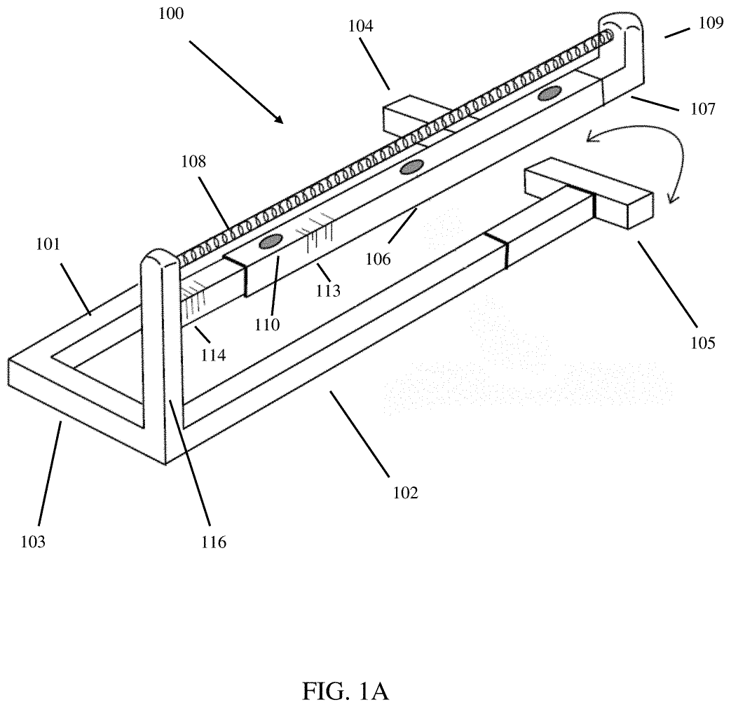

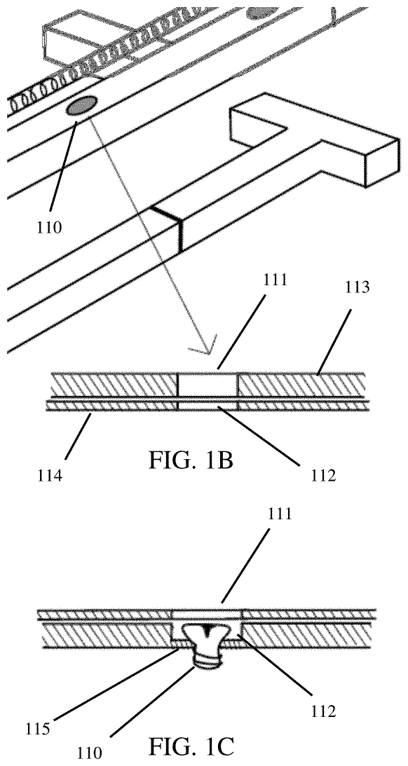

FIG. 1a shows a perspective diagram of the jig 100 by itself. Note that it has two, long, lower arms 101 and 102, which would extend forward from a rear connecting arm 103 so that they pass on either side of a circular saw blade (shown in a later figure). Two feet 104 and 105 are at the forward ends of long arms 101 and 102 respectively, and would press against an edge of a piece of wood (shown in a later figure), keeping the entire assembly and saw perpendicular to the piece of wood. The circular saw (shown in a later figure) is attached to the jig at an upper arm 106, the upper arm 106 extending at, for example, slider location 107, one piece of the upper arm sliding within the other piece of the upper arm, the joint being represented by slider location 107. Spring 108 holds the front end 109 of upper arm 106 within or outside of the slider of upper arm 106 so that there is pressure of the cross arms 104 and 105 against the piece of wood (shown in a later figure) as the circular saw is pushed forward.

FIG. 1b shows a blow up perspective view of FIG. 1a, and a cross section of hole 110 in upper arm 106. When the two pieces of the slider, 113 and 114, in upper arm 106 are aligned properly, holes 111 and 112 in each of the outer slider piece 113 and inner slider piece 114 respectively are aligned as well. More specifically, in the exemplary embodiment shown in FIG. 1c, a screw or bolt 115 can be inserted into the aligned holes 111 and 112 and screwed into a through hole in inner slider 114 with a ledge 115 and further into a threaded hole or through hole and nut in the guard plate usually found on a circular saw (shown in a later figure), attaching the circular saw to the jig 100. In alternate embodiments (not shown), instead of using screws or bolts which pass through the interior of one of the slider pieces, exterior clamps or flanges can be used on the outer slider piece 113, and screws or bolts can be run through holes in those exterior clamps or flanges. Other methods for fastening the outer slider 113 to a safety plate on a cutting tool as are familiar to those skilled in the art may also be used and are intended to be covered by this invention. Note that either section 113 having end piece 109 in FIG. 1a can be the outer slider and the remainder 114 of upper arm 106 can be the inner slider piece, as shown in this figure, or vice versa (not shown).

A typical distance between lower arms 101 and 102 is between 1″ and 8″, more preferably 4″ to 5″. This depends on both the model of cutting tool this jig is attached to, such as a circular saw or dremel tool, and the configuration of the feet 104 and 105, if used. In another embodiment of this invention, rear connecting arm 103 can be adjusted in length, to allow for changing the distance between the lower arms 101 and 102 to reconfigure the jig for different models of cutting tool.

It is desirable to make the jig light weight, since it will be carried and used with a cutting tool for long periods of a day in construction, but it must also be strong to withstand both its intended use and the incidental abuse common on a construction site. Therefore, the jig 100 should be constructed of sturdy materials, as it is attached to a cutting tool such as a circular saw which may be heavy, and used to guide cuts through materials. In a preferred embodiment the jig is generally constructed of aluminum framing, other materials include, but are not limited to, steel, heavy duty plastic, and resin composites. Different parts of the jig may be constructed of different materials for ease of fabrication, molding and use.

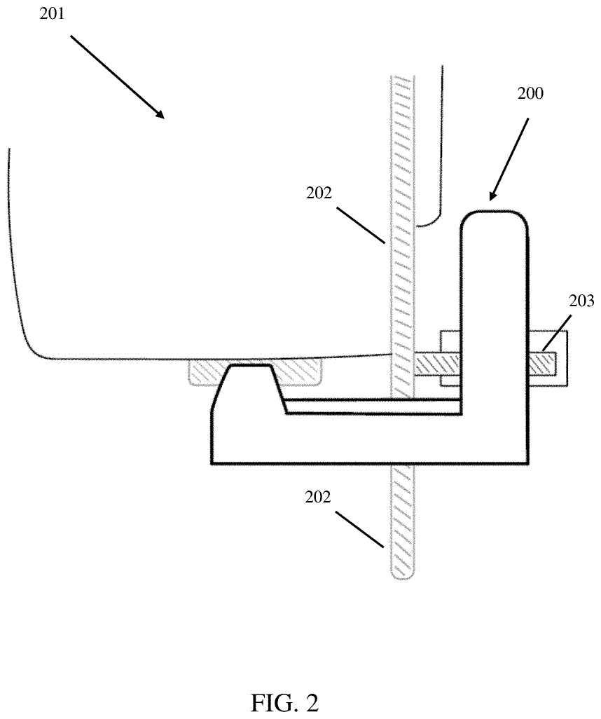

FIG. 2 shows a rear view of the jig 200, in black lines, attached to a circular saw 201, in grey lines. Item 202 is the circular saw blade, which passes vertically between the arms 101 and 102 in FIG. 1. Plate 203 is the typical guard plate found on a circular saw, which sets the level the blade cuts at. This plate 203 would be fastened to the outer part 112 of the slider of the upper arm 106, as described earlier, at multiple locations such as hole 110 in upper arm 106 to keep the blade parallel to the arms 101 and 102 and in particular aimed between feet 104 and 105.

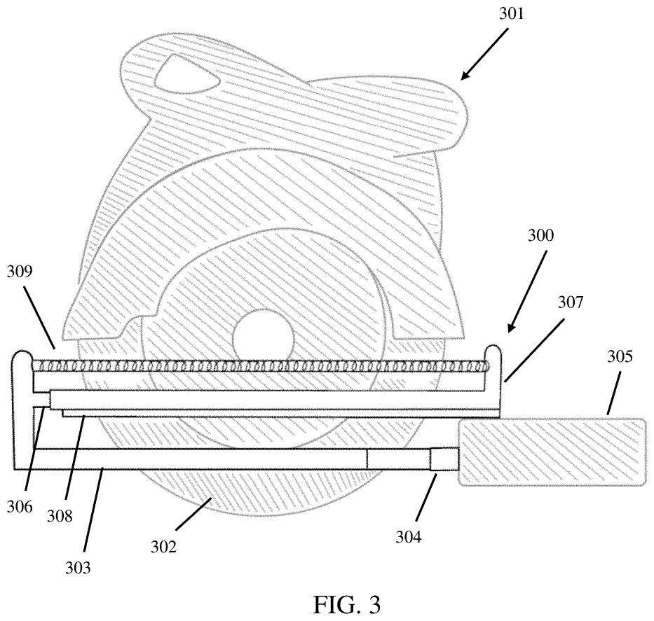

FIG. 3 shows a side view of the jig 300 attached to a circular saw 301. Lower arm 303 has foot 304 which presses against a piece of wood 305. The inner part 306 of the upper arm slides freely inside the outer part 307 of the upper arm, the outer part is fastened to plate 308 of circular saw 301 as described previously, and spring 309 applies tension, holding foot 304, as well as its counterpart foot on the other arm, item 104 in FIG. 1A but hidden in this drawing, against the wood 305. Note also that in this embodiment inner part 306 of the upper arm is attached rigidly to lower arm 303 as well as its counterpart lower arm, shown as 101 in FIG. 1A but hidden in FIG. 3, by connector section 103 in FIG. 1A. As the circular saw blade 302 is pushed forward into the wood 305, cutting it, spring 309 stretches, applying even more force to keep the jig and foot 304 (as well as its counterpart on the other lower arm, not shown) pressed against the wood, keeping the cut straight. When the cut is done and the saw is removed from the wood, spring 309 pulls the jig back to its ready position to press the feet against another piece of wood for cutting a controlled straight line, perpendicular to the edge of the wood in this embodiment.

While the spring in FIG. 3 is shown exposed, in other embodiments of the spring loaded section of the subject jig invention it may be enclosed or sheathed to help prevent construction debris from getting into the spring, damage to the spring or injuries due to getting fingers into the spring when it contracts. The sheathing may be a flexible type, such as is found in “coiling” type hoses which expand when pressurized, or rigid sliding covers such as seen in upper arm 303.

A typical “pull out” distance for inner part 306 and outer part 307 to slide relative to each other may be between 8″ and 18″, meaning spring 309 must accommodate a stretch and contraction of this range. A preferred pull out distance is in the 10″ to 12″ range. It may be desirable to provide a mechanism (not shown) to adjust the tension of the spring to accommodate cutting different lengths of cuts into board 305. This adjustment may be by means of, but is not limited to, adjusting an end position of the spring 309 within the upper arm. Fixed stops or other mechanisms such as replacement of inner part 306 or 307 with pieces of different lengths may also be used to adjust the pull out distance allowed for the relative sliding of inner part 306 and 307. For additional flexibility, replacement of sliding parts of one or both lower arms 303 may also be made to accommodate a changed pull out distance of the upper arm 306 plus 307.

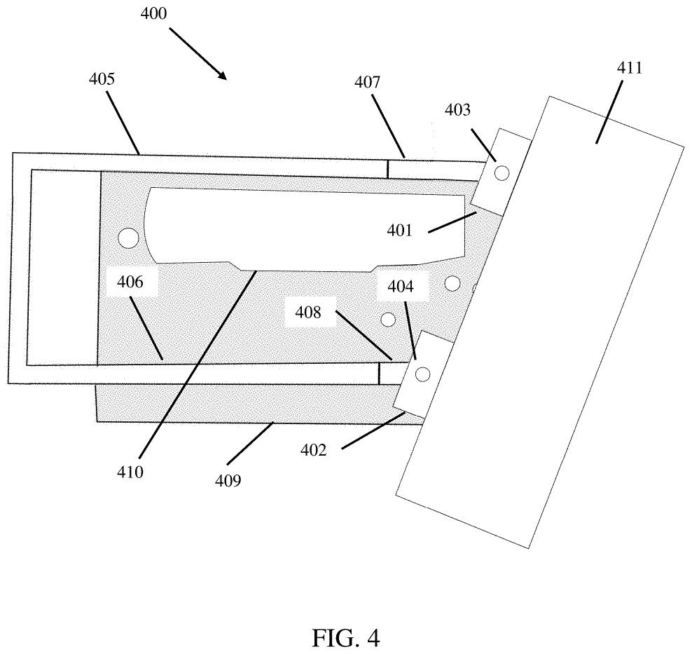

FIG. 4 shows another embodiment of this invention, viewed from the bottom. In this embodiment of the jig 400, crosspieces 401 and 402 are mounted on pivots 403 and 404 on lower arms 405 and 406 respectively. Lower arms 405 and 406 each have sliding mechanisms, one front lower arm section 407 sliding relative to a rear lower arm portion in the lower arm 405 and one front lower arm section 408 sliding relative to a rear lower arm portion in the lower arm 406 respectively, allowing adjustment of the relative lengths of lower arms 405 and 406. An example circular saw lower guard plate 409 is shown, along with its large opening 410 in which the circular saw blade (302 of FIG. 3) would spin. As can be seen in this figure, by means of a combination of adjusting the relative lengths of the lower arms 405 and 406 and adjusting the angles of feet 401 and 402, the angle the jig is pressed against a sheet of material 411 can be adjusted in a well controlled way. This allows the jig to make a cut in a cutting line direction at a desired angle relative to the edge of the sheet of material, such as, but not limited to, 45 degrees, for different purposes in construction such as making an angled joint for a joist.

In another embodiment of this invention, one lower arm is fixed, while length adjustment is only provided in the other lower arm. While this reduces flexibility of the achievable angles in the jig, it reduces manufacturing cost and potential failure points. In another embodiment of this invention, for additional flexibility in cutting at different angles, replacement of sliding parts 407 and 408 of one or both lower arms 405 and 406 may also be made. In another embodiment of this invention, for additional flexibility in cutting at different angles, both lower arms 405 and 406 may be fixed in length rather than have sliding sections but replacement of a section of at least one lower arm such as 407 or 408 with a section of different length to change the relative length of lower arm 405 and 406 may be made to change the angle of the cutting line direction. In another embodiment of this invention, the feet 401 and 402 can also be replaced with feet at different fixed angles rather than using a pivot to allow cutting lines at specific, commonly used angles such as, but not limited to, 30 degrees, 45 degrees and 60 degrees. These angled feet can be combined with and potentially permanently attached to different matching fixed length sections such as 407 and 408 to provide a “fast swap” capability of cutting these angles.

Markings can be placed on the pivots 403 and 404 and/or feet 401 and 402, to measure angles of rotation of the feet 401 and 402 and set the angle of a planned cut. Markings can also be placed on the sliding lower arms 405 and 406 so that their relative lengths can be adjusted to match the angles of the feet 401 and 402. It can be seen that specific relative total lengths of sliding lower arms 405 and 406 along with specific angular rotations of feet 401 and 402 are needed in combination to keep feet 401 and 402 pressed against board 407.

In one embodiment of the invention feet 401 and 402 can rotate freely on pivots 403 and 404, relying on relative length adjustment of lower arms 405 and 406 to determine the angle feet 401 and 402 take to press against sheet of material 411. In another embodiment of this invention, the pivots 403 and 404 may have friction or locking mechanisms (not shown), in order to keep the pivots securely rotated to particular angles. In another embodiment, L shaped rather than T shaped feet are used, with the short leg of the L extending outward or inward. In another embodiment of the invention, no feet are used, and lower arms 405 and 406 merely terminate in flat or rounded ends which are pressed against the wood.

In one embodiment of the invention, if a saw or cutting tool with a relatively thin blade is used, such as a jig saw or Sawzall, connected straight line segments could be cut in the sheet of material 411 by adjusting relative lengths of lower arms 405 and 406 and, if used, angles of feet 401 and 402 after line segments of a desired length have been cut. This could allow, for example, cutting angled and perpendicular line segments in a tile to go around a plumbing fixture.

It should be understood that the foregoing description is only illustrative of the embodiments. It should also be understood that the embodiments disclosed herein may be used individually or in any suitable combination thereof. Various alternatives and modifications can be devised by those skilled in the art without departing from the embodiments, in particular using a range of tools having a variety of cutting blade types in the apparatus such as, but not limited to, a jig saw or a dremel, and cutting a variety of materials other than wood such as, but not limited to, plastic, composite, stone, tiles, and metal. Accordingly, the present embodiments are intended to embrace all such alternatives, modifications and variances.

What is claimed is:

1. An apparatus attachable to a portable cutting tool for cutting along a particular line in a sheet of material, the apparatus comprising; an alignment jig, the jig comprising at least two projecting arms which rest against the edge of the sheet of material which is going to be cut, and a sliding spring loaded jig section which allows the portable cutting tool to move into and through a portion of the sheet of material while providing forward force on the projecting arms so as to keep the projecting arms pressed against the edge of the sheet of material.

2. An apparatus as described in claim 1, further comprising a mechanism to adjust the tension in the spring loaded jig section.

3. An apparatus as described in claim 1, further comprising a mechanism to adjust the length of the slider in the spring loaded jig section.

4. An apparatus as described in claim 1, further comprising a mechanism to change the length of at least a first projecting arm, such that an angle of a cutting line direction other than one perpendicular to the edge of the sheet of material can be cut in the sheet of material.

5. An apparatus as described in claim 1, further comprising feet on the ends of the projecting arms, the feet pressing against the edge of the sheet of material.

6. An apparatus as described in claim 5, further comprising pivots on the connections of the feet to the projecting arms, such that the feet can remain flatly pressed against the edge of the sheet of material even when a cutting line direction other than one perpendicular to the edge of the sheet of material is cut.

7. An apparatus as described in claim 4, further comprising markings on the first projecting arm such that the angle of the cutting line direction can be quantitatively set.

8. An apparatus as described in claim 6, further comprising markings on at least one of the first projecting arm or in the region of at least one pivot such that the angle of the cutting line direction can be quantitatively set.

9. An apparatus as described in claim 7, further comprising a mechanism on a rear connecting arm of the alignment jig so that the distance between the projecting arms can be adjusted.

10. A method of cutting a particular line in a sheet of material, comprising; attaching an alignment jig to a portable cutting tool, pressing at least two projecting arms on the jig against the edge of the sheet of material, and pushing the portable cutting tool forward, cutting along a predetermined cutting line through a portion of the sheet of material while a spring loaded jig section pushes the two projecting arms against the edge of the sheet of material, thereby defining the cutting line direction the cutting tool may take.

11. A method as described in claim 11, further comprising adjusting the tension in the spring loaded jig section in order to provide proper pressure against the edge of the sheet of material.

12. A method as described in claim 11, further comprising adjusting the length of the slider in the spring loaded jig section in order to provide proper pressure against the edge of the sheet of material.

13. A method as described in claim 11, further comprising independently adjusting the amount of projection of at least a first projecting arm from the jig before making the cutting action, and thereby cutting an angle of a line direction other than one perpendicular to the edge of the sheet of material in the sheet of material.

14. A method as described in claim 11, further comprising pressing feet on the ends of the projecting arms against the edge of the sheet of material.

15. A method as described in claim 14, further comprising independently adjusting the amount of projection of at least one of the projecting arms from the jig before making the cutting action, and thereby cutting an angle of a cutting line direction other than one perpendicular to the edge of the sheet of material in the sheet of material

16. A method as described in claim 15, further comprising adjusting pivots on the connections of the feet to the projecting arms, thereby cutting an angle of a cutting line direction other than one perpendicular to the edge of the sheet of material while pressing the feet flatly against the edge of the sheet of material.

17. A method as described in claim 13, further comprising adjusting the length of the first projecting arm according to markings on the first projecting arm in order to determine and set the angle of the cutting line direction.

18. A method as described in claim 16, further comprising adjusting at least one of the length of the first projecting arm according to markings on the first projecting arm or the angle of both feet according to markings in the region of one pivot in order to determine and set the angle of the cutting line direction.

19. A method as described in claim 17, further comprising adjusting the pivots on the connections of the feet to the projecting arms according to markings on the pivots in order to determine and set the angle of the cutting line direction.

20. A method as described in claim 15, further comprising adjusting the length of the at least one projecting arm and angle of both feet by replacing an end section of both projecting arms with alternate sections having the correct length and foot angle to set the angle of the cutting line direction.
